(19) United States
(12) Patent Application Publication
(10) Pub. No.: US 2011/0087377 A1
(43) Pub. Date: Apr. 14, 2011

(54) EQUIPMENT MANAGEMENT SYSTEM

(75) Inventors: Hideo NABESHIMA, Hirakata (JP); Toshiyuki Miyake, Neyagawa (JP); Haruhiko Hyousu, Ikoma (JP); Junichi Suzuki, Ikeda (JP)

(73) Assignee: Panasonic Electric Works Co., Ltd., Osaka (JP)

(21) Appl. No.: 12/902,417

(22) Filed: Oct. 12, 2010

(30) Foreign Application Priority Data
Oct. 13, 2009 (JP) 2009-236627

(51) Int. Cl. G05B 15/00; G06F 21/00

(52) U.S. Cl. 700/276; 700/275; 726/3

(57) ABSTRACT

An equipment management system includes: an equipment control device having a control unit connected to the equipment control server to transmit a control signal for controlling the load of the equipment in cooperation with the equipment control server; an identifiable medium; a reading device having an acquisition unit for acquiring identification information of the medium present in a management target area, a determination unit for determining presence/absence of a user carrying the medium in the management coverage depending on the acquired information, and an instruction unit for instructing the control unit to control the load of the equipment depending on the determination result; and an authentication server having an authentication unit for performing authentication based on the identification information. The transmitting operation from the instruction unit of the reading device to the control unit of the equipment control device is performed in a wireless manner.

### FIELD OF THE INVENTION

The present invention relates to an equipment management system and, more particularly, to an equipment control performed by the equipment management system depending on whether or not a user is present.

### BACKGROUND OF THE INVENTION

Equipments such as illumination devices or air conditioning devices installed in a building or the like are desirably designed to save energy. For realization of energy saving in the equipments, an equipment control system is associated with a dweller management system. Since presence of a user is detected by the dweller management system, energy saving can be achieved by turning off the power supply to the equipments when electric power is unnecessarily consumed in a place where no user exists.

JP2008-192095A discloses a system in which an entrance/exit management server transmits entrance/exit management information to a central monitoring device which in turn controls equipments such as illumination devices or air conditioning devices based on the entrance/exit management information.

In the system, a dweller management system includes the entrance/exit management server and a card reader for transmitting identification information obtained by the entrance/exit management server, while an equipment control system includes the central monitoring device and the equipments controlled by the central monitoring device. The dweller management system transmits the information to an equipment control server serving as the central monitoring device. The equipment control server controls the equipments based on the information.

An article entitled “Evaluation of an Energy Saving Illumination/Air-Conditioning System Using User Movement Information and Environment Data”, which was contributed to the July 2009 issue of Mitsubishi Electric Technology Journal, reports that equipment control is performed by using dweller management information and power consumption can be reduced by turning off the power supply to equipments in a place where no user exists.

Meanwhile, it is sometimes the case that a tenant wishes to newly introduce a dweller management system to a building provided with only an equipment control system. In order for the new dweller management system to perform communications with the equipment control server of the equipment control system provided in the building, the dweller management system needs to be designed to conform with the specifications of the equipment control system. No problem arises if the dweller management system and the equipment control system are provided by a same manufacturer.

In case where the dweller management system is provided by a manufacturer differing from the manufacturer of the equipment control system, however, it is typical that the dweller management system and the equipment control system are not matched each other due to lack of compatibility. This makes it difficult for the dweller management system to perform communications with the equipment control server of the equipment control system.

### SUMMARY OF THE INVENTION

In view of the above, the present invention provides an equipment management system capable of controlling equipments depending on presence/absence of a user regardless of the specifications of an existing equipment control system even when combined with the equipment control system provided by a manufacturer differing from that of the equipment management system.

In accordance with a first aspect of the present invention, there is provided an equipment management system coexisting with an equipment control system in which a load of an equipment is controlled by an equipment control server.

The equipment management system includes: an equipment control device having a control unit connected to the equipment control server to transmit a control signal for controlling the load of the equipment in cooperation with the equipment control server; an identifiable medium; a reading device having an acquisition unit for acquiring identification information of the medium present in a management target area, a determination unit for determining presence/absence of a user carrying the medium in the management coverage depending on the acquisition situation of the identification information in the acquisition unit, and an instruction unit for instructing the control unit to control the load of the equipment depending on the determination result of the determination unit; and an authentication server having an authentication unit for performing authentication based on the identification information acquired by the acquisition unit.

Further, the transmitting operation from the instruction unit of the reading device to the control unit of the equipment control device is performed in a wireless manner.

With the present invention set forth above, the equipment can be controlled by transmitting the instruction to the control unit when the load of the equipment is controlled based on the presence/absence of the user determined depending on whether or not the identification information from the medium. The equipment includes an illumination device, an air conditioning device or the like, and control interfaces thereof are well known. Therefore, the control unit can transmit a control signal for controlling the equipment based on the received instruction. The control unit directly transmits the control signal to the equipment and, therefore, has no need to know the specifications of the equipment control system.

Thus, the equipment can be controlled not only by the equipment control system already provided in the building but also by the present equipment management system even though the manufacturer of the equipment management system introduced by a tenant differs from that of the equipment control system. In the latter case, the equipment management system can readily control the equipment depending on the presence/absence of the user.

### BRIEF DESCRIPTION OF THE DRAWINGS

The objects and features of the present invention will become apparent from the following description of preferred embodiments, given in conjunction with the accompanying drawings, in which:

FIG. 1 is a view showing an example of an arrangement of equipments and devices in a room of a building.

FIGS. 2A and 2B is a view showing a connection between an equipment control system and an equipment management system.

FIGS. 3A, 3B and 3C are views showing configurations of an ID management server, an entering/exiting ID management device and a user management device, respectively.

FIG. 4 is a view showing a configuration of an equipment control device.

FIGS. 5A and 5B are views showing configurations of a tag reader and a tag, respectively.

FIGS. 6A and 6B are views showing configurations of a hybrid reader and an IC card, respectively.

FIGS. 7A and 7B are views showing a user presence/absence management table and an equipment use management table, respectively.

FIGS. 8A and 8B are tables showing a tag reader and a control target thereof and an equipment control device and a control target thereof, respectively.

FIGS. 9A through 9D illustrate different examples of commands generated by the tag reader.

FIG. 10 is a flowchart illustrating an equipment control operation performed by the tag reader.

FIG. 11 is a flowchart illustrating an operation for updating the user presence/absence management table and an equipment use management table.

FIG. 12 is a view showing a time sequence of an equipment control operation performed by the tag reader.

### DETAILED DESCRIPTION OF THE PREFERRED EMBODIMENTS

Hereinafter, embodiments of the present invention will be described in more detail with reference to accompanying drawings which form a part hereof.

Hereinafter, description will be made on a case where an equipment management system in accordance with an embodiment of the present invention is applied to a building in which an equipment control system is provided to control equipments for illumination and air conditioning. The equipment management system, by a tag reader, reads ID information from a tag preliminarily distributed to a user and wirelessly and directly transmits a command to an equipment control device provided in the building, thereby performing the control of building equipments depending on presence/absence of a user.

### Overall Configuration

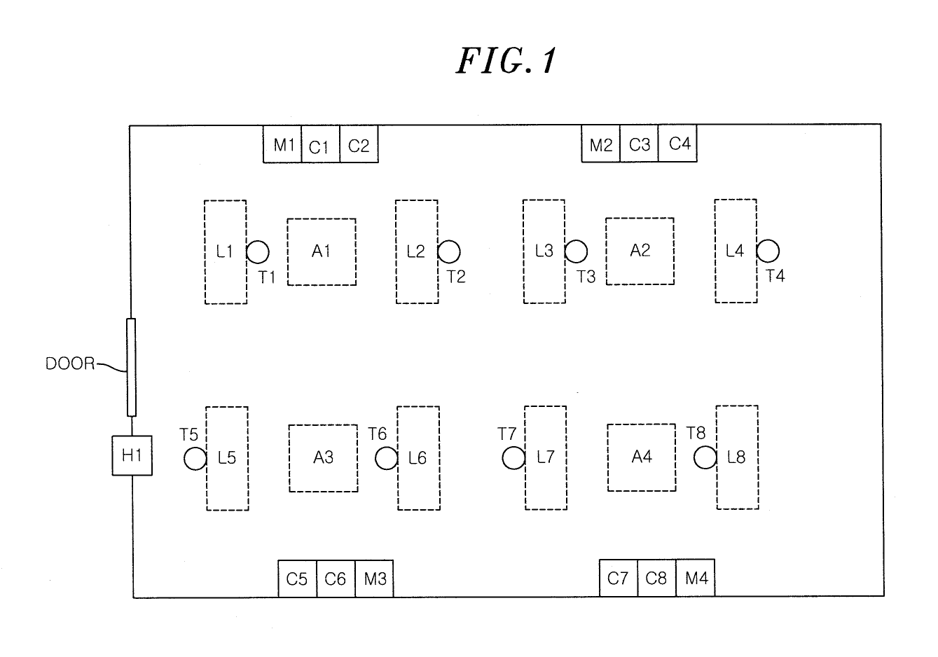

Referring to FIG. 1, there are shown equipments provided in a building and devices making up an equipment management system provided by a tenant, both of which are arranged within the room of a building.

As shown in FIG. 1, illumination devices L1 to L8, air conditioning devices A1 to A4, measuring instruments M1 to M4, equipment control devices C1 to C8, tag readers T1 to T8 and a hybrid reader H1 are arranged within the room. The numerals suffixed to the alphabets designating the respective equipments merely signify different individuals of the same kind of equipments. In the following description, if appropriate, the equipments will be designated by using only the alphabets without the numerals.

In FIG. 1, the equipments include the illumination devices L, the air conditioning devices A and the measuring instruments M provided in a building and controlled by a building's equipment control system. The equipment management system includes the equipment control devices C, the tag readers T and the hybrid reader H.

The equipment control devices C1, C3, C5 and C7 are connected to the illumination devices L1 and L2, the illumination devices L3 and L4, the illumination devices L5 and L6 and the illumination devices L7 and L8, respectively. The respective equipment control devices C1, C3, C5 and C7 perform controls on the illumination devices L connected thereto. The equipment control devices C2, C4, C6 and C8 are connected to the air conditioning devices A1, A2, A3 and A4, respectively. The respective equipment control devices C2, C4, C6 and C8 perform controls on the air conditioning devices A connected thereto.

The illumination devices L and the air conditioning devices A indicated by broken lines in FIG. 1 are installed in the ceiling of the room. The tag readers T are installed on desks or other places on the floor free from being disturbed. The measuring instruments M and the equipment control devices C are installed on walls.

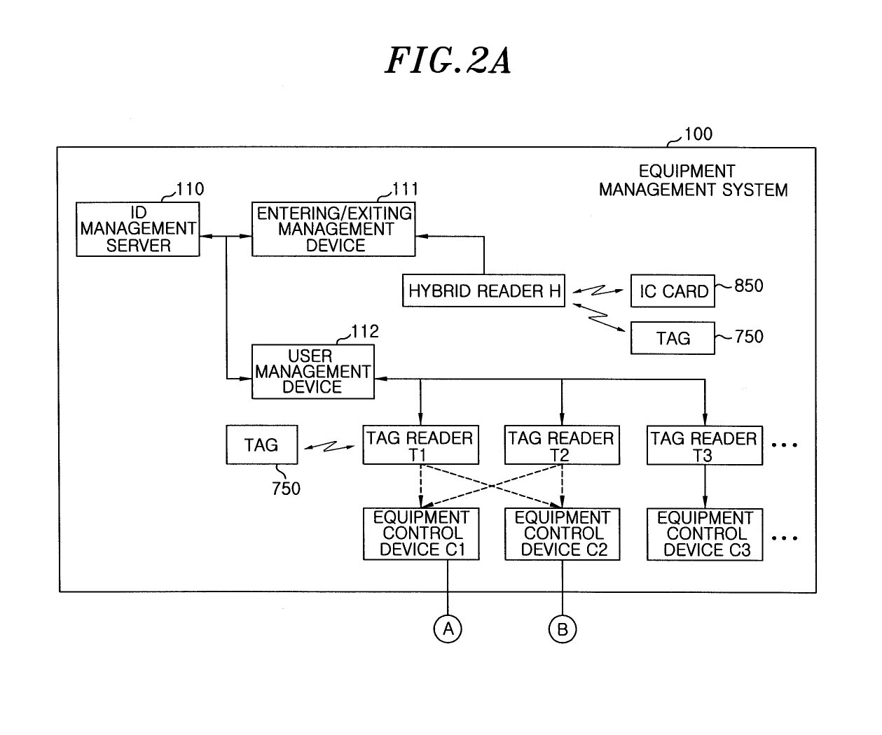

FIGS. 2A and 2B shows the connection between the equipments and devices shown in FIG. 1. The equipments provided in the building are controlled by the building's equipment control system 200 as well as the equipment management system 100, both of which coexist in the building.

### Configuration of Equipment Control System 200

Now, description will be made on the building's equipment control system 200.

The building's equipment control system 200 includes an equipment control server 210, an illumination control device 211, an air conditioner control device 212, a measuring instrument control device 213, illumination devices L, air conditioning devices A and measuring instruments M.

The illumination control device 211 has a function of performing such control as turning on/off the illumination devices L, changing the luminance of the illumination devices L or the like. The air conditioner control device 212 has a function of performing such control as turning on/off the air conditioning devices A, changing the temperature setting of the air conditioning devices A or the like.

The measuring instrument control device 213 has a function of acquiring the measurement values measured by the measuring instruments M and transmitting the acquired measurement values to the equipment control server 210. The measuring instruments M may include a thermometer used in controlling the temperature of the air conditioning devices based on the measured temperature.

The equipment control server 210 has a function of performing equipment control, e.g., a function of instructing the illumination control device 211 to change the luminances of the illumination devices L on a time zone basis. In addition, the equipment control server 210 has a function of recording, on a log, the temperature received from the measuring instrument control device 213 and instructing the air conditioner control device 212 to change the temperature settings of the air conditioning devices A based on the records of the log.

### Configuration of Equipment Management System 100

Next, description will be made on an embodiment of the equipment management system 100 in accordance with the present.

The equipment management system 100 includes an ID management server 110, an entering/exiting management device 111, a user management device 112, a hybrid reader H, tag readers T and equipment control devices C, and an integrated circuit (IC) card and a tag carried by a user.

The hybrid reader H reads ID information from a tag or an IC card at the entrance/exit of the user. The tag readers T read ID information from a tag when the user is present. The ID management server 110 performs authentication of the ID information read by the hybrid reader H and the tag readers T. The entering/exiting management device 111 and the user management device 112 perform an entrance/exit management and user management, respectively, based on the authentication result from the ID management server 110. The tag reader T transmits a command for controlling a building's equipment to a corresponding equipment control device C based on the user management situation of the user management device 112. The equipment control device C controls the building's equipments in response to the command received from the tag reader T.

Hereinafter, description will be made on the respective components.

<ID Management Server 110>

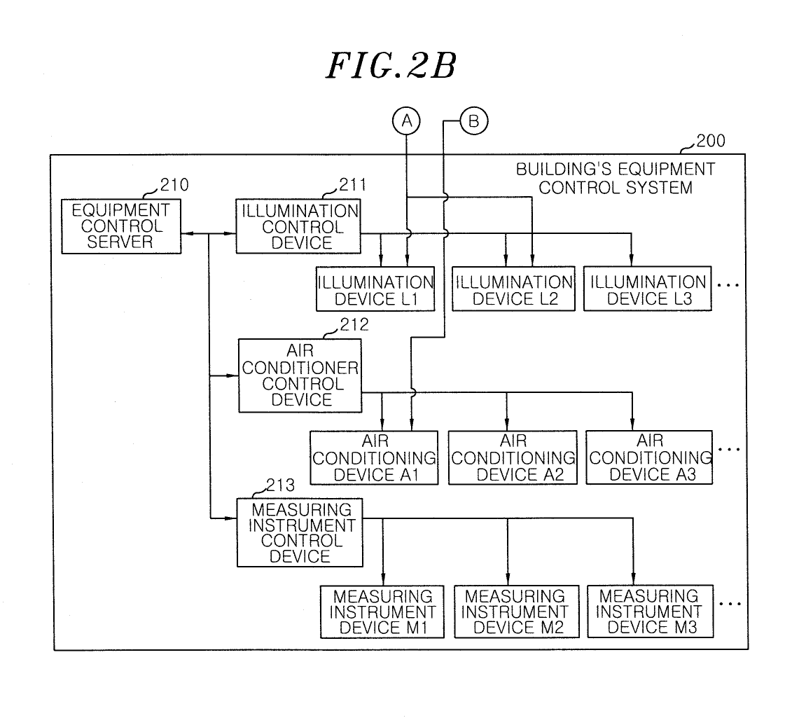

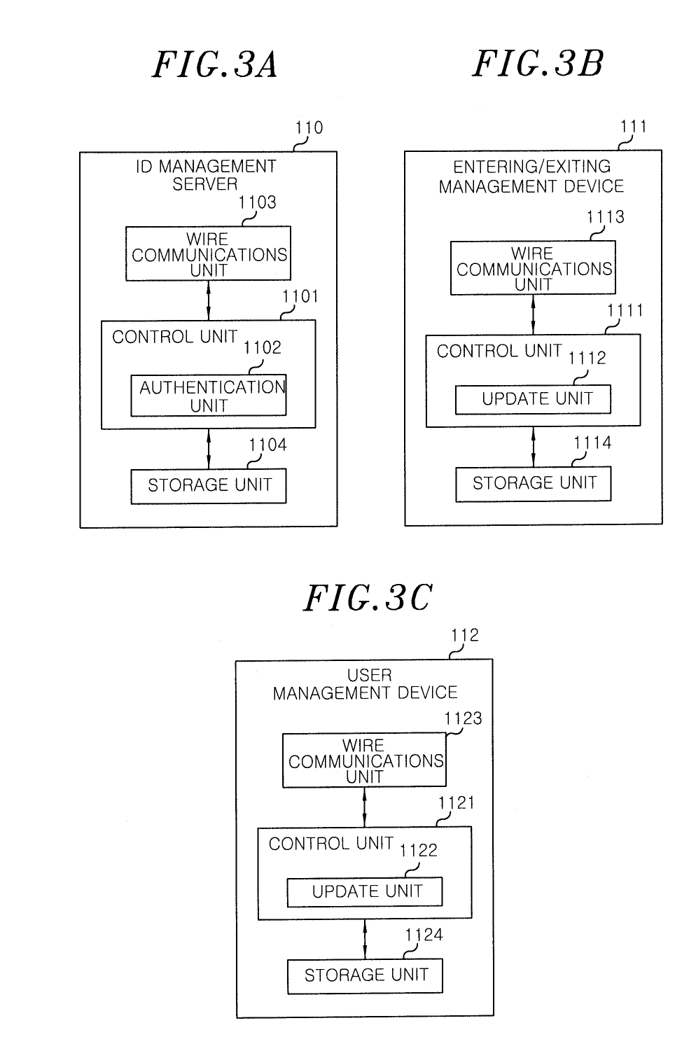

Referring to FIG. 3A, there is shown a schematic configuration of the ID management server 110. The ID management server 110 has a function of receiving the ID information read by the hybrid reader H and the tag reader T via the entering/exiting management device 111 and the user management device 112, performing authentication of the received ID information and transmitting the authentication result to the entering/exiting management device 111 and the user management device 112. The ID management server 110 includes a control unit 1101, an authentication unit 1102, a wire communications unit 1103 and a storage unit 1104.

The wire communications unit 1103 has a function of receiving the ID information from the entering/exiting management device 111 and the user management device 112 and transmitting the authentication result to the entering/exiting management device 111 and the user management device 112.

The storage unit 1104 is a storage medium for storing the ID information of the user authorized to use the equipments.

The control unit 1101 has a function of instructing the authentication unit 1102 to perform authentication of the ID information received by the wire communications unit 1103 and transmitting the authentication result through the wire communications unit 1103.

The authentication unit 1102 is included in the control unit 1101 and serves to perform authentication by comparing the received ID information with the ID information stored in the storage unit 1104.

Thus it is possible to make sure that the equipment is used by only the user authorized to use.

<Entering/Exiting Management Device>

Referring to FIG. 3B, there is schematically shown a configuration of the entering/exiting management device 111.

The entering/exiting management device 111 has a function of, based on the ID information received from the hybrid reader H, performing the entrance/exit management in which the user entering/exiting the room is identified. The entering/exiting management device 111 includes a control unit 1111, an update unit 1112, a wire communications unit 1113 and a storage unit 1114.

The wire communications unit 1113 has a function of receiving the ID information read by the hybrid reader H, transmitting the received ID information to the ID management server 110 and receiving the authentication result from the ID management server 110.

The storage unit 1114 is a storage medium for storing an entrance/exit management table showing the ID of the user entering/exiting the room.

The control unit 1111 has a function of instructing the update unit 1112 to, based on the authentication result received by the wire communications unit 1113, update the entrance/exit management table stored in the storage unit 1114.

The update unit 1112 is included in the control unit 1111 and serves to update the entrance/exit management table stored in the storage unit 1114, based on the authentication result received by the wire communications unit 1113.

Referring to FIG. 3C, there is shown a configuration of the user management device 112.

The user management device 112 has a function of, based on the ID information received from the tag reader T, identifying presence/absence of the user at a specific position in the room. The user management device 112 includes a control unit 1121, an update unit 1122, a wire communications unit 1123 and a storage unit 1124.

The wire communications unit 1123 has a function of receiving the ID information read by the tag reader T, transmitting the received ID information to the ID management server 110 and receiving the authentication result from the ID management server 110.

The storage unit 1124 is a storage medium for storing a user presence/absence management table, an equipment use management table, a tag reader coverage table and an equipment control device coverage table.

The user presence/absence management table refers to a table showing a tag reader and ID of a user located in a region covered by the tag reader. The specific position in the room can be identified depending on which of the tag readers T has detected a tag carried by the user. Since the positional relationship between the tag readers T and the equipments is fixed as shown in FIG. 1, from the user presence/absence management table, it can be known which of the equipments is positioned closer to the user.

The equipment use management table refers to a table showing the ID of the user using the equipment and that of the equipment.

The tag reader coverage table refers to a table showing the equipments to be controlled by the tag readers T when the tag readers T transmit commands to the equipment control devices C, based on the presence/absence situation of the user, to control the equipments, i.e., the illumination devices L and/or the air conditioning devices A.

The equipment control device coverage table refers to a table showing the corresponding equipment control devices C to which the commands have to be transmitted to control the equipments to be controlled.

The details of the respective tables will be described later.

The control unit 1121 has a function of instructing the update unit 1122 to, based on the authentication result received by the wire communications unit 1123, update the user presence/absence management table and the equipment use management table stored in the storage unit 1124.

The update unit 1122 is included in the control unit 1121 and serves to, based on the authentication result received by the wire communications unit 1123, update the user presence/absence management table and the equipment use management table stored in the storage unit 1124.

<Equipment Control Device D>

The equipment control devices C are wire-connected to the illumination devices L and the air conditioning devices A and have a function of receiving the commands transmitted from the tag readers T, generating control commands for performing the on/off control of the equipments based on the commands thus received and transmitting the generated control commands to the equipments. The equipment control devices C may include an operational switch such as a mechanical switch or a liquid crystal switch panel, installed on an inner wall of the building, the operational switch being controlled manually or remotely.

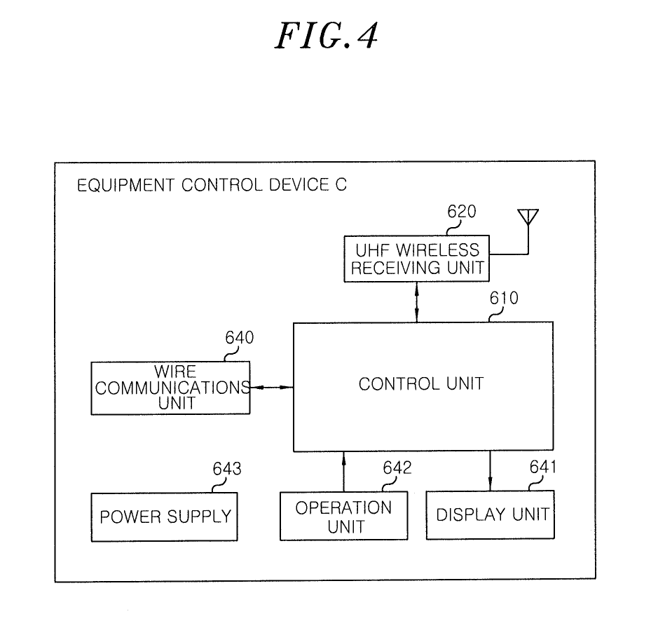

Hereinafter, the configuration of the equipment control devices C will be described with reference to FIG. 4.

Each of the equipment control devices C includes a control unit 610, a UHF wireless receiving unit 620, a wire communications unit 640, a display unit 641 and an operation unit 642. Each of the equipment control devices C is driven by a power supply 643.

The UHF wireless receiving unit 620 has a function of receiving the commands carried on a radio frequency (RF) signal and transmitted from the tag readers T.

The control unit 610 has a function of generating control commands for controlling the equipments based on the commands received by the UHF wireless receiving unit 620. The control unit 610 controls the equipments by transmitting the generated control commands to the equipments through the wire communications unit 640.

The wire communications unit 640 is wire-connected to the equipments of the building and has a function of transmitting the control commands generated by the control unit 610 to the equipments.

The display unit 641 refers to, e.g., a display for displaying states of the equipments controlled by each of the equipment control devices C. For example, if the equipment control device C controls an illumination device L, the display unit 641 displays the on/off states of the illumination device L. Similarly, if the equipment control device C controls an air conditioning device A, the display unit 641 displays the on/off states of the air conditioning device A and a set temperature of the air conditioning device A instructed most recently by the equipment control device C.

The operation unit 642 refers to, e.g., buttons for manually controlling the equipments controlled by the equipment control devices C. The equipment control devices C can generate control commands based on the commands received from the tag readers T or instruction inputted from the operation unit 642 by using the buttons and transmit the control commands to the equipments, thereby controlling the equipments.

<Tag Readers T>

The tag readers T are installed at a plurality of places in the room each of which has a function of reading the ID information from the tag carried by the user. In addition, the tag readers T have functions of, based on the received ID information, generating commands for instructing the equipment control devices C to control the illumination devices L or the air conditioning devices A and transmitting the generated commands.

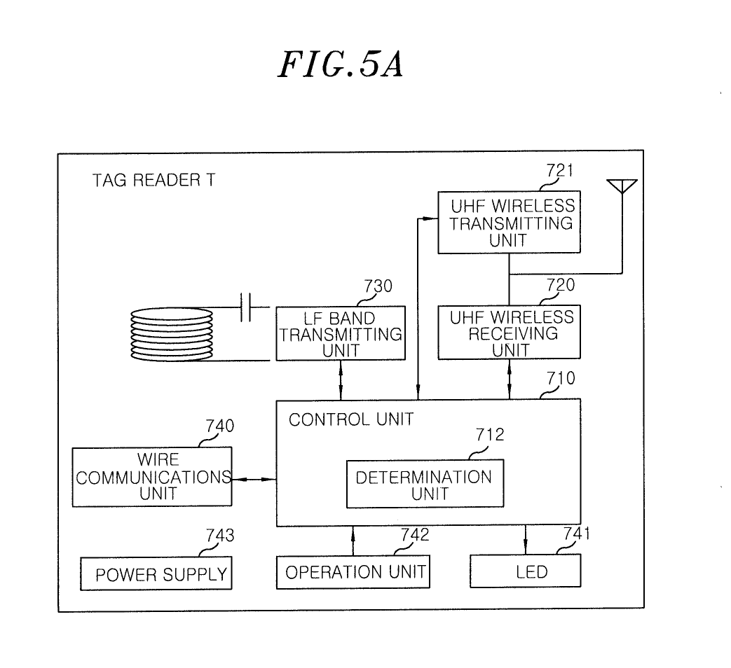

Hereinafter, the configuration of the tag readers T will be described with reference to FIG. 5A.

Each of the tag readers T includes a control unit 710, a UHF wireless receiving unit 720, a UHF wireless transmitting unit 721, a low frequency (LF) signal transmitting unit 730, a wire communications unit 740, a light emitting diode (LED) 741 and an operation unit 742. Each of the tag readers T is driven by a power supply 743.

The LF signal transmitting unit 730 has a function of periodically transmitting a presence confirmation signal Q for the detection of a tag as an LF signal.

The UHF wireless receiving unit 720 has a function of receiving a presence confirmation response signal R transmitted from the tag as an RF signal.

The control unit 710 has a function of performing the user presence/absence management based on the presence confirmation response signal R received by the UHF wireless receiving unit 720 and transmitting commands for equipment control to the equipment control devices C depending on the presence/absence situation of the user.

The control unit 710 extracts the ID information of the user carrying the tag from the presence confirmation response signal R received by the UHF wireless receiving unit 720 and transmits the extracted ID information to the user management device 112 through the wire communications unit 740. The user management device 112 transmits the received ID information to the ID management server 110. The ID management server 110 authenticates the received ID information and transmits the authentication result to the user management device 112. The user management device 112 transmits the authentication result to the tag readers T. The tag readers T receive the authentication result.

The control unit 710 updates a user ID management list if the authentication result received by the wire communications unit 740 is affirmative. The user ID management list refers to a list of ID information read from the tags existing in the coverage of the relevant tag readers T. The user ID management list shows the IDs allotted to the users existing in the coverage of the relevant tag readers T. The control unit 710 transmits the updated user ID management list to the user management device 112 through the wire communications unit 740. The user ID management device 112 updates the user management table and the equipment use management table based on the received user ID management list.

The control unit 710 includes a determination unit 712. The determination unit 712 determines an equipment to be controlled and a control to be performed on the equipment, based on the equipment use management table received by the wire communications unit 740. For example, the determination unit 712 makes a determination in such a way that, if an ID is registered in the item of the illumination device L of the equipment use management table, a command is generated to turn on the illumination device L and further that, if no ID is registered therein, a command is generated to turn off the illumination device L.

The wire communications unit 740 refers to an interface through which communications with the user management device 112 are carried out. The wire communications unit 740 may be directly connected to the user management device 112 via a wired LAN or may be connected to the user management device 112 through a personal computer connected with a USB.

The LED 741 lights while the tag reader T is in operation, for example, and indicates the operating state of the tag reader T. The operation unit 742 is a switch for starting up the tag reader T.

<Tag 750>

Next, the configuration of the tag 750 will be described with reference to FIG. 5B.

The tag 750 includes a control unit 760, a UHF wireless transmitting unit 770, an LF signal receiving unit 780, a storage unit 790, an LED 791, an operation unit 792 and a battery 793. The tag 750 is driven by the battery 793.

The LF signal receiving unit 780 has a function of receiving a presence confirmation signal Q transmitted by the tag reader T as an LF signal.

The control unit 760 has a function of generating a presence confirmation response signal R in response to the presence confirmation signal Q received by the LF signal receiving unit 780 and instructing the UHF wireless transmitting unit 770 to transmit the presence confirmation response signal R. The presence confirmation response signal R generated by the control unit 760 includes the ID information allotted to the user carrying the tag 750 and stored in the storage unit 790.

The storage unit 790 is, e.g., a non-volatile memory and stores the ID information allotted to the user carrying the tag 750.

The LED 791 indicates the operating state of the tag 750. For example, the LED 791 may light when the tag 750 is in operation and flicker to indicate the reception of the presence confirmation signal Q or the transmission of the presence confirmation response signal R.

The operation unit 792 is a switch for starting up the tag 750. The tag 750 is normally used in an energized state. For the purpose of power saving, the tag 750 is designed in such a way that the switch thereof can be manually turned off when the tag 750 is moved away from the user management area.

<Hybrid Reader H>

The hybrid reader H is installed near the doorway of a room and has a function of reading the ID information from the IC card or the tag carried by the user. The hybrid reader H unlocks the door based on the ID information.

The hybrid reader H transmits the read ID information to the entering/exiting management device 111 which in turn transmits the received ID information to the ID management server 110. The ID management server 110 authenticates the received ID information and transmits the authentication result to the entering/exiting management device 111 which in turn transmits the received authentication result to the hybrid reader H. The hybrid reader H unlocks the door based on the received authentication result.

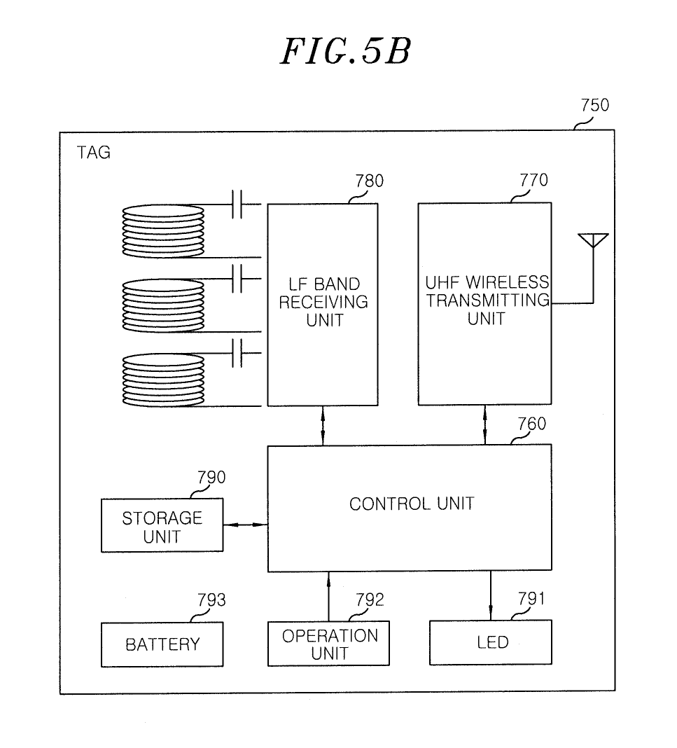

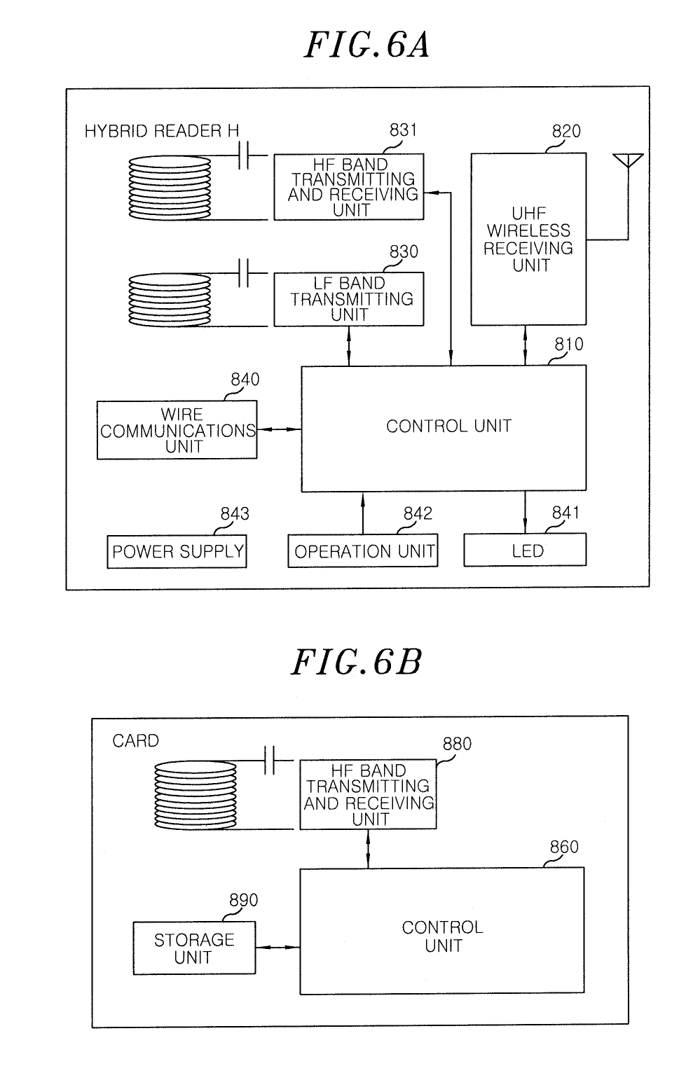

Hereinafter, a configuration of the hybrid reader H will be described with reference to FIG. 6A.

The hybrid reader H includes a control unit 810, a UHF wireless receiving unit 820, an LF signal transmitting unit 830, an HF signal transmitting/receiving unit 831, a wire communications unit 840, an LED 841 and an operation unit 842. The hybrid reader H is driven by a power supply 843.

As compared with the tag readers T, the hybrid reader H is additionally provided with a function of authenticating the IC card as well as the tag. Therefore, the control unit 810, the UHF wireless receiving unit 820, the LF signal transmitting unit 830, the wire communications unit 840 and the operation unit 842 have the same functions as the functions of the corresponding components of the tag readers T. In contrast to the tag readers T transmitting the ID information to the user management device 112, the hybrid reader H transmits the ID information to the entering/exiting management device 111. Furthermore, although the tag readers T transmit equipment control commands to the equipment control devices C depending on the presence situation of the user, the hybrid reader H outputs a command for instructing a door control device to unlock the door.

Next, description will be made on the components of the hybrid reader H that do not exist in the tag readers T.

The HF signal transmitting/receiving unit 831 has a function of transmitting and receiving an HF signal for performing authentication of the IC card. The IC card receives a request signal of high frequency band transmitted from the HF signal transmitting/receiving unit 831. If a response signal of high frequency band is transmitted from the IC card, the HF signal transmitting/receiving unit 831 receives the response signal.

The control unit 810 extracts the ID information of the user carrying the IC card from the response signal received by the HF signal transmitting/receiving unit 831 and transmits the extracted ID information to the entering/exiting management device 111 through the wire communications unit 840. If the authentication result received by the wire communications unit 840 is affirmative, the control unit 810 outputs a signal instructing a door control device to unlock the door.

<IC Card 850>

Next, a configuration of the IC card 850 will be described with reference to FIG. 6B.

The IC card 850 includes a control unit 860, an HF signal transmitting/receiving unit 880 and a storage unit 890. The IC card 850 is driven by electromotive force induced by the HF band signal received by the HF signal transmitting/receiving unit 880.

The HF signal transmitting/receiving unit 880 has a function of receiving the request signal of the high frequency band transmitted from the hybrid reader H and transmitting the response signal generated by the control unit 860.

If the HF signal transmitting/receiving unit 880 receives the request signal, the control unit 860 reads the ID information allotted to the user carrying the IC card 850 which is stored in the storage unit 890 and generates the response signal containing the ID information. The control unit 860 transmits the generated response signal through the HF signal transmitting/receiving unit 880.

The storage unit 890 is, e.g., a non-volatile memory and stores the ID information allotted to the user carrying the IC card 850.

### Data

Now, data used in the equipment management system 100 will be described.

First, description will be made on the user presence/absence management table, the equipment use management table, the tag reader coverage table and the equipment control device coverage table stored in the storage unit 1124 of the equipment management system 100.

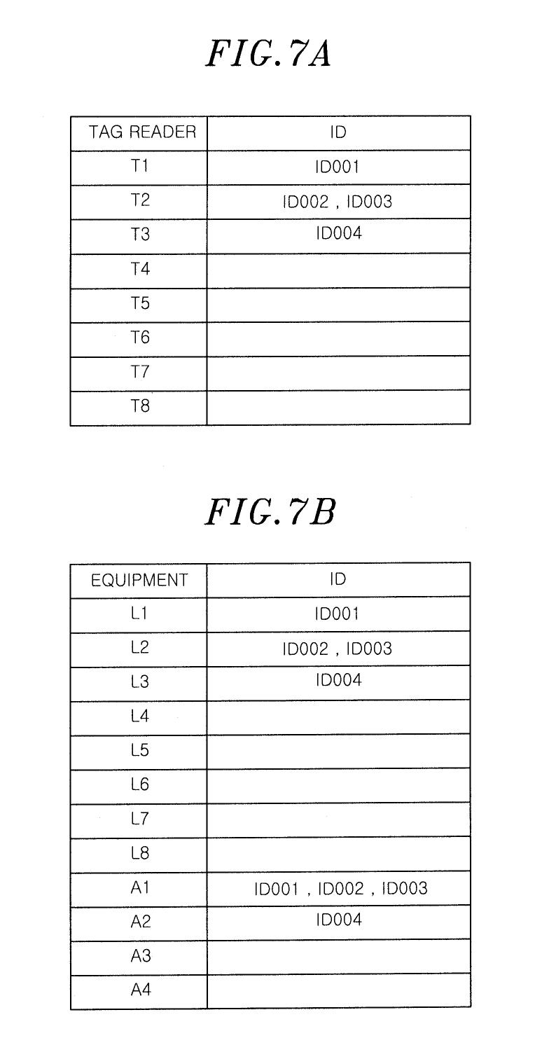

As shown in FIG. 7A, the user presence/absence management table refers to a table showing position of the user in the room. That is, FIG. 7A shows the correspondence relationship between the tag readers and the users, e.g., the user of ID001 located in the coverage of the tag reader T1 and the users of ID002 and ID003 located in the coverage of the tag reader T2. The blanks mean that no user is located in the coverage of the tag readers. The user presence/absence management table is updated based on the ID information periodically detected by the respective tag readers T. In this regard, the coverage of the tag reader T refers to the range within which a tag can receive the presence confirmation signal Q transmitted from the tag reader T.

As shown in FIG. 7B, the equipment use management table refers to a table showing situation of the equipments used by the users. That is, FIG. 7B shows the correspondence relationship between the equipments and the users, e.g., the illumination device L1 used by the user of ID001, the illumination device L2 used by the users of ID002 and ID003 and the air conditioning device A1 used by the users of ID001, ID002 and ID003. The blanks mean that no user makes use of the equipments. Just like the user presence/absence management table, the equipment use management table is updated based on the ID information periodically detected by the respective tag readers T.

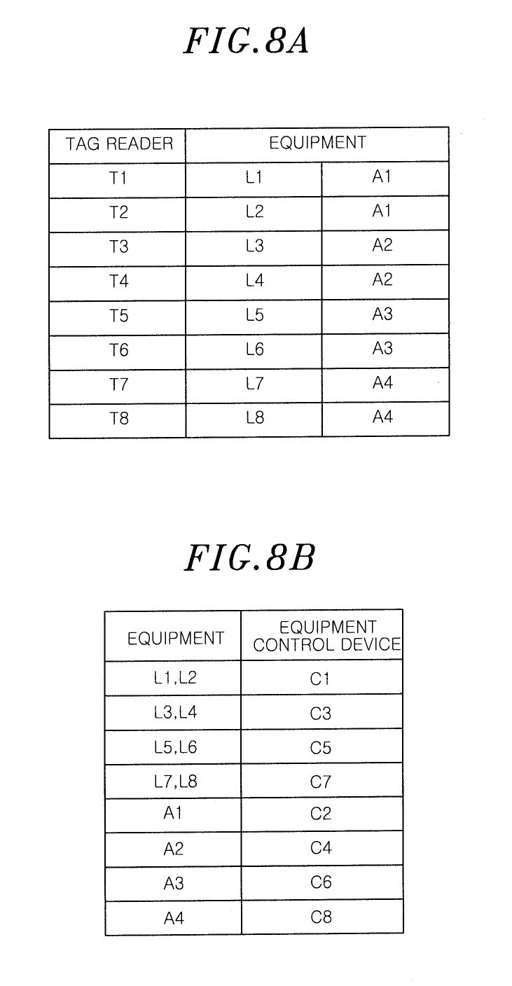

As shown in FIG. 8A, the tag reader coverage table refers to a table showing the tag readers and the equipments to be controlled by each of the tag readers T and is used when the tag readers T transmit commands to the equipment control devices C, based on the presence situation of the user, to control the equipments, i.e., the illumination devices L and the air conditioning devices A. That is, the tag reader T1 controls the illumination device L1 and the air conditioning device A1 and the tag reader T2 controls the illumination device L2 and the air conditioning device A2 in FIG. 8A. This is set so that, as shown in FIG. 1, each of the tag readers T can control the equipment existing in the coverage thereof. The tag reader coverage table is preliminarily prepared in accordance with the positional relationship between the tag readers T and the equipments.

As shown in FIG. 8B, the equipment control device coverage table refers to a table showing an equipment to be controlled and the equipment control device C to which the commands are to be transmitted in order to control the equipment. As shown in FIG. 8B, the illumination devices L1 and L2 is controlled by the equipment control device C1 and the air conditioning device A1 controlled by the equipment control device C2. The correspondence relationship is determined by the connection between the equipment control devices C and the equipments as shown in FIGS. 2A and 2B. The equipment control device coverage table can be preliminarily prepared in accordance with the connection relationship between the equipment control devices C and the equipments.

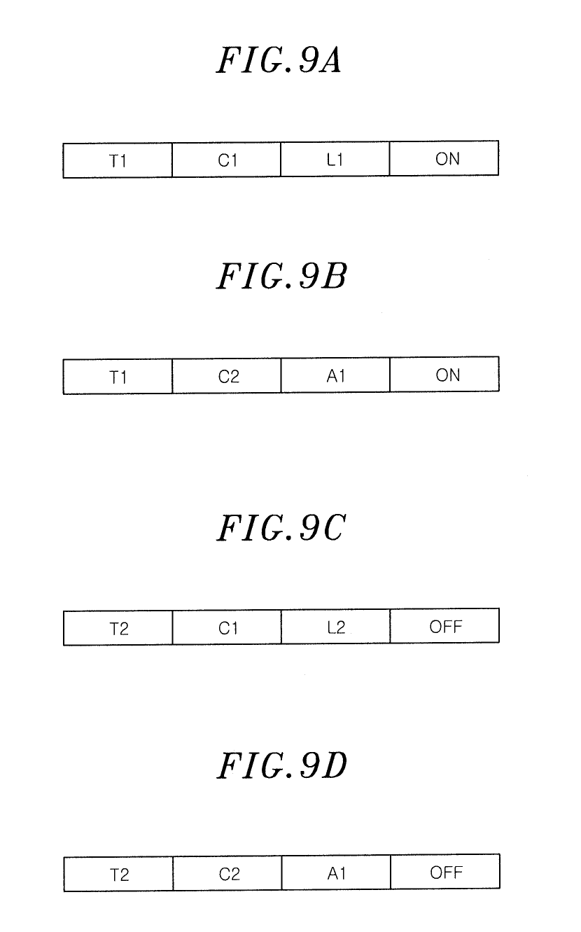

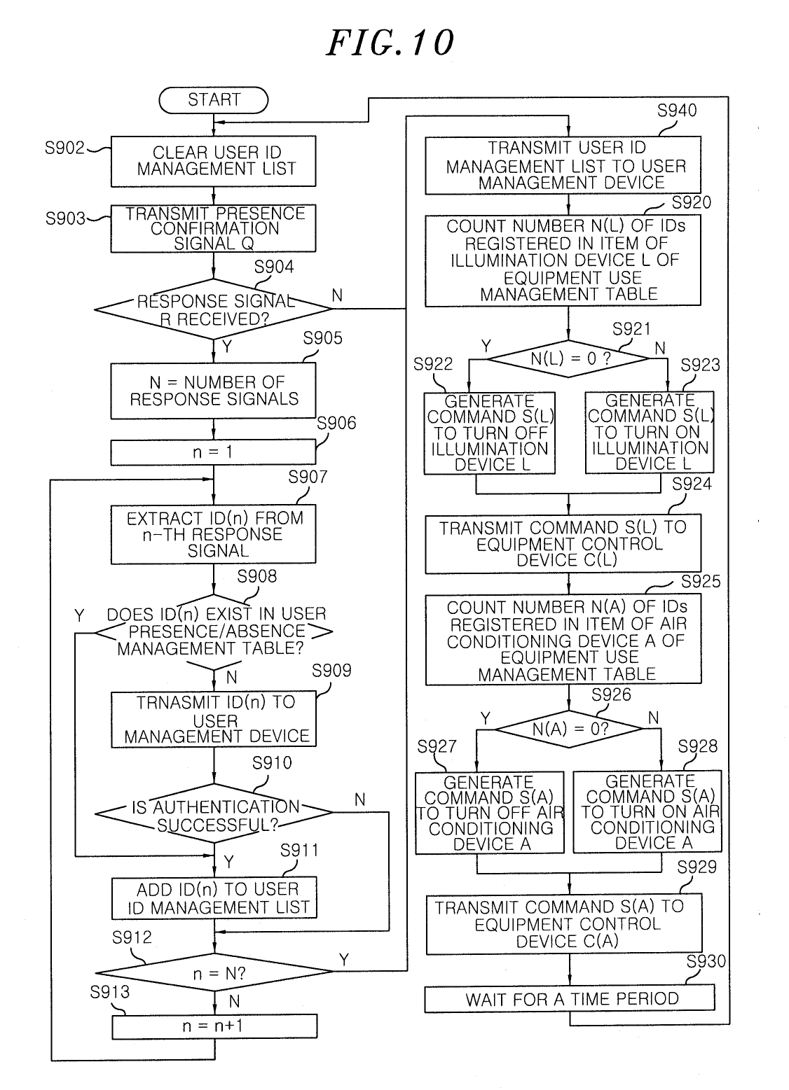

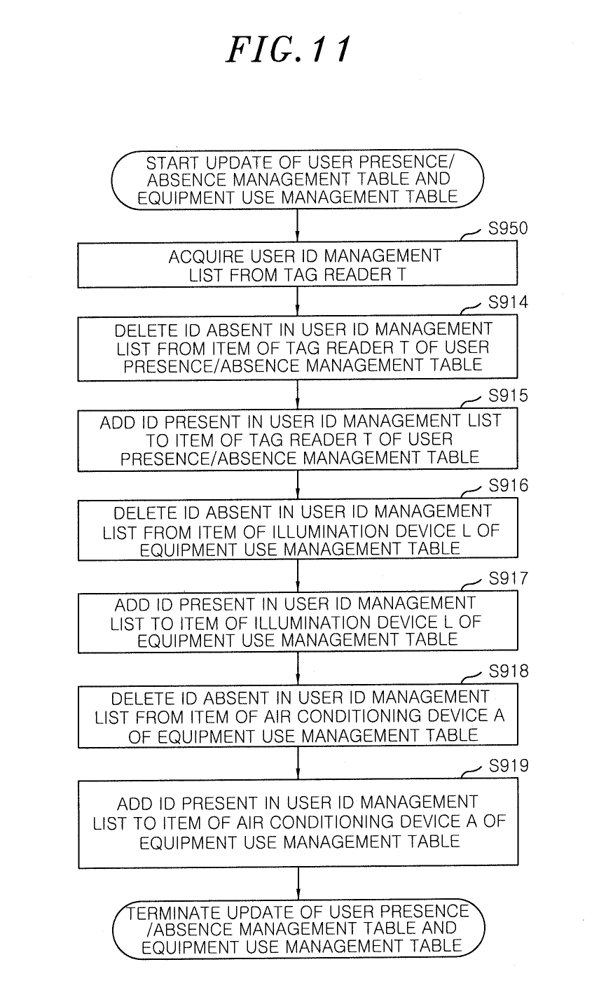

Next, the commands generated by the tag readers T and transmitted to the equipment control devices C will be described with reference to FIGS. 9A through 9D. FIG. 9A shows a command transmitted from the tag reader T1 to instruct the equipment control device C1 to turn on the illumination device L1. FIG. 9B shows a command transmitted from the tag reader T1 to instruct the equipment control device C2 to turn on the air conditioning device A1.

FIG. 9C shows a command transmitted from the tag reader T2 to instruct the equipment control device C1 to turn off the illumination device L2. FIG. 9D shows a command transmitted from the tag reader T2 to instruct the equipment control device C2 to turn off the air conditioning device A1.

The tag readers T determine the target equipments to be controlled by the tag readers T based on the tag reader coverage table stored in the storage unit 1124 of the user management device 112 and also determine the equipment control device C to which the commands are to be transmitted for the control of the target equipment, based on the equipment control device coverage table held in the storage unit 1124 of the user management device 112.

Furthermore, the tag readers T determine the control contents to be performed with respect to the equipments based on the equipment use management table held in the storage unit 1124 of the user management device 112. Then, the tag readers T generate commands. As shown in FIGS. 9A through 9D, the commands generated by the tag readers T contain identifiers indicating the equipment control devices C by which to execute the commands. Each of the equipment control devices C executes only the command that contains its own identifier.

### Equipment Control Operation

Referring now to FIG. 10, description will be made on the operations of one of the tag readers T for detecting the tag located in the coverage thereof, transmitting the ID information of the detected tag and performing equipment control based on the equipment use management table updated by the user management device 112.

First, the tag reader T clears the user ID management list (S902).

Then, the tag reader T transmits a presence confirmation signal Q (S903). If the tag reader T receives presence confirmation response signal R transmitted from a tag that has received the presence confirmation signal Q (if Yes in S904), the tag reader T counts the number N of the received dwelling confirmation response signals R (S905) and initializes the variable n indicative of the serial numbers of the N presence confirmation response signals R to become equal to 1 (S906).

Next, the tag reader T extracts an ID(n) from the n-th presence confirmation response signal R (S907). If the ID(n) is not registered in the user presence/absence management table of the user management device 112 (if No in S908), the tag reader T transmits the ID(n) to the user management device 112 (S909). The user management device 112 transmits the received ID(n) to the ID management server 110 and receives the authentication result from the ID management server 110. The user management device 112 transmits the received authentication result to the tag reader T. If the ID(n) is successfully authenticated (if Yes in S910), the tag reader T adds the ID(n) to the user ID management list (S911).

If the ID(n) is already registered in the user ID management table of the user management device 112 (if Yes in S908), the tag reader T adds the ID(n) to the user ID management list without the authentication process (S911).

If the authentication of the ID(n) is not successful (if No in S910), the tag reader T does not add the ID(n) to the user ID management list.

If No in S912, the processes set forth above is repeated by increasing the variable n until the variable n becomes equal to N (S913).

If the variable n becomes equal to N (if Yes in S912), it means that the IDs of all users located in the coverage of the tag reader T have been registered in the user ID management list.

If the user ID management list is transmitted to the user management device 112 (S940), the user management device 112 updates the user presence/absence management table and the equipment use management table thereof based on the received user ID management list.

Subsequently, the tag reader T acquires the updated equipment use management table from the user management device 112 and transmits commands to the respective equipments based on the equipment use management table.

First, the tag reader T counts the number N(L) of the IDs registered in the equipment use management table as the item of the illumination devices L controlled by the tag reader T (S920). If N(L) is equal to 0 (if Yes in S921), the tag reader T generates a command S(L) for turning off the illumination devices L (S922). If N(L) is not equal to 0 (if No in S921), the tag reader T generates a command S(L) for turning on the illumination devices L (S923). The tag reader T transmits the generated commands S(L) to the equipment control devices C(L) to control the illumination devices L (S924).

Next, the tag reader T counts the number N(A) of the IDs registered in the equipment user ID management table as the item of the air conditioning devices A controlled by the tag reader T (S925). If N(A) is equal to 0 (if Yes in S926), the tag reader T generates a command S(A) for turning off the air conditioning devices A (S927). If N(A) is not equal to 0 (if No in S926), the tag reader T generates a command S(A) for turning on the air conditioning devices A (S928). The tag reader T transmits the generated commands S(A) to the equipment control devices C(A) for controlling the air conditioning devices A (S929).

If the above processing comes to an end, the tag reader T waits for a specified time period (S930), after which the flow returns back to step S902. In other words, the tag reader T periodically repeats the processing of steps S902 through S929.

### Update Operation of User Presence/Absence and Equipment Use Management Tables

Now, the operation of the user management device 112 for updating the user presence/absence and the equipment use management table based on the user ID management list received from the tag reader T will be described with reference to FIG. 11.

First, the user management device 112 acquires the user ID management list from the tag reader T (S950).

Subsequently, the user management device 112 updates the item of the tag reader T in the user presence/absence management table. More specifically, the user management device 112 deletes the IDs absent in the user ID management list from the item of the tag reader T of the user presence/absence management table (S914). Furthermore, the user management device 112 adds the IDs present in the user ID management list to the item of the tag reader T of the user presence/absence management table (S915). This means that only the IDs of the users located in the coverage of the tag reader T are registered in the item of the tag reader T of the user presence/absence management table.

Similarly, the user management device 112 updates the item of the illumination devices L of the equipment use management table, the illumination devices L being controlled by the tag reader T. More specifically, the user management device 112 deletes the IDs absent in the user ID management list from the item of the illumination devices L of the equipment use management table (S916). Furthermore, the user ID management device 112 adds the IDs present in the user ID management list to the item of the illumination devices L of the equipment use management table (S917). This means that only the IDs of the users using the illumination devices L are registered in the item of the illumination devices L of the equipment use management table.

Similarly, the user management device 112 updates the item of the air conditioning devices A of the equipment use management table, the air conditioning devices A being controlled by the tag reader T. More specifically, the user management device 112 deletes the IDs absent in the user ID management list from the item of the air conditioning devices A of the equipment use management table (S918). Furthermore, the user management device 112 adds the IDs present in the user ID management list to the item of the air conditioning devices A of the equipment use management table (S919). This means that only the IDs of the users using the air conditioning devices A are registered in the item of the air conditioning devices A of the equipment use management table.

Thus, the operation of the user management device 112 for updating the user presence/absence and the equipment use management table is terminated.

### Example of Equipment Control Operation

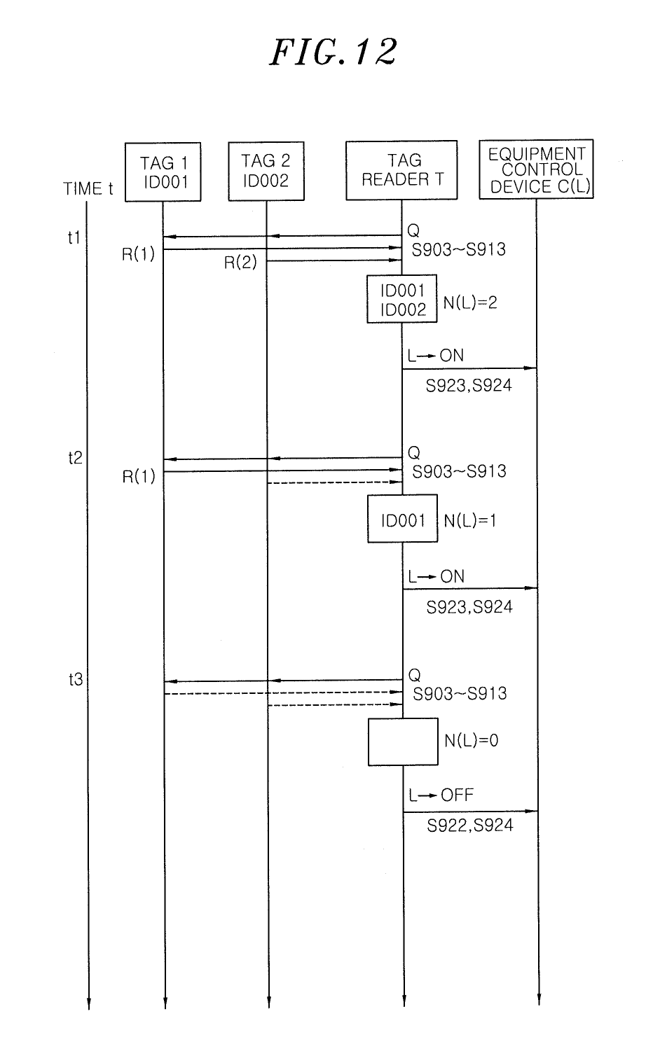

Hereinafter, one specific example of the equipment control operation performed by the tag reader T will be described with reference to a time sequence shown in FIG. 12.

Referring to FIG. 12, there will be described an operation example in which the tag reader T detects tags 1 and 2 and transmits a command to the equipment control device C(L) for controlling the illumination devices L serving as the control target of the tag reader T.

For the sake of simplification, it is assumed that the illumination devices L are not the control target of other tag readers.

First, the tag reader T transmits a presence confirmation signal Q at a time point t1 (S903). If a user of ID001 having the tag 1 and a user of ID002 having the tag 2 are in the coverage of the tag reader T, the tags 1 and 2 receive the presence confirmation signal Q and transmit presence confirmation response signals R1 and R2, respectively.

Upon receiving the presence confirmation response signals R1 and R2 (if N=2 in S904 and S905), the tag reader T updates the user ID management list to register ID001 and ID002 in the user ID management list (S905 through S913). The tag reader T transmits the user ID management list to the user management device 112 (S940). The user ID management device 112 updates the user presence/absence and the equipment user ID management tables based on the user ID management list (S914 through S919).

Since ID001 and ID002 are registered in the item of the illumination devices L of the equipment use management table of the user management device 112 (since N(L)=2 in S921), the tag reader T transmits a command for instructing the equipment control device C(L) to turn on the illumination devices L (S923 and S924).

Next, the tag reader T transmits a presence confirmation signal Q at a time point t2 (S903). If only the user of ID001 having the tag 1 remains in the coverage of the tag reader T and the user of ID002 having the tag 2 has moved to other place, only the tag 1 receives the presence confirmation signal Q and transmits a presence confirmation response signal R1.

Upon receiving the presence confirmation response signal R1 (if N=1 in S904 and S905), the tag reader T updates the user ID management list by registering ID001 in the user ID management list (S905 through S913). The tag reader T transmits the user ID management list to the user management device 112 (S940). The user management device 112 updates the user presence/absence and the equipment use management tables based on the user ID management list (S914 through S919).

Since ID001 is registered in the item of the illumination devices L of the equipment use management table of the user management device 112 (since N(L)=1 in S921), the tag reader T transmits a command for instructing the equipment control device C(L) to turn on the illumination devices L (S923 and S924).

In addition, the tag reader T transmits a presence confirmation signal Q at a time point t3 (S903). If no user having a tag is present in the coverage of the tag reader T, the tag reader T fails to receive any of the presence confirmation response signal (S904).

Thus, the user ID management list is left in blank. The tag reader T transmits the user ID management list to the user management device 112 (S940). The user management device 112 updates the user presence/absence and the equipment user ID management tables based on the user ID management list (S914 through S919).

Since the item of the illumination devices L of the equipment use management table of the user management device 112 is left in blank (since N(L)=0 in S921), the tag reader T transmits a command for instructing the equipment control device C(L) to turn off the illumination devices L (S922 and S924).

In the manner set forth above, the tag reader T performs the equipment control depending on the presence situation of the user.

### Modified Embodiments

The foregoing embodiment may be modified as follows.

(1) In the foregoing embodiment, the determination unit 712 provided in the control unit 710 of the tag reader T determines the control contents to be performed on the equipments. However, the present invention is not limited thereto. For example, a determination unit may be provided in the equipment control device C so that the equipment control device C can determine the control contents to be performed on the equipments. This can be realized by allowing the equipment control device C to store the ID of the user using the equipments, instead of the equipment use management table held by the user management device 112.

(2) In the foregoing embodiment, it is determined that, if the tag reader T fails to receive the presence confirmation response signal R after transmitting the presence confirmation signal Q, a user is not present in the coverage of the tag reader T. However, it may be determined that, if the tag reader T fails to receive the presence confirmation response signal R in a predetermined period of time, a user does not exist in the coverage of the tag reader T.

This can be realized in the following manner. When the tag reader T fails to receive the presence confirmation response signal R after transmitting the presence confirmation signal Q in the foregoing embodiment, the tag reader T can wait to receive the presence confirmation response signal R for a predetermined period of time instead of immediately deleting the ID. The ID may be deleted after a lapse of the predetermined period of time. Upon receiving the presence confirmation response signal R, the waiting time is reset to 0.

This can help to avoid the possibility that the user carrying a tag is misjudged as not to be present in the coverage of the tag reader by failing to receive the presence confirmation response signal R due to a communications error.

In case of adding the ID to the user presence/absence management table as well as deleting the ID from the user presence/absence management table, the ID may be added after receiving the presence confirmation response signal several times.

This can, be realized in the following manner. When the ID is added to the user presence/absence management table in the foregoing embodiment, the number of reception times of the presence confirmation response signal R may be counted instead of just adding the ID. The ID is added when the number of reception times exceeds a predetermined number of times. If the number of reception times does not exceed the predetermined number of times, the ID is not added and the number of reception times is reset to 0.

This eliminates the possibility that a user is wrongly determined to be present in the coverage of the tag reader T even when the user carrying the tag which has transmitted the presence confirmation response signal R just passes by the coverage of the tag reader T.

(3) In the foregoing embodiment, there is performed a polling tag detection method in which the tag reader T transmits the presence confirmation signal Q and the tag transmits the presence confirmation response signal R in response to the presence confirmation signal Q. However, the present invention is not limited thereto. It may be possible to perform an event-driven tag detection method. In this case, the tag reader T does not periodically transmit the presence confirmation signal Q. Instead, the tag periodically transmits a signal notifying the presence thereof. The tag reader T detects the tag by receiving the signal transmitted therefrom.

(4) In the foregoing embodiment, if the equipment control device C receives a command for controlling the equipments, the command is converted to a control command and then transmitted to the equipments. However, the control command may not be transmitted to the equipments. For example, there is no need to transmit the control command to the equipments if no change will occur in the state of the equipments by the control command.

This can be realized by allowing the equipment control device C to detect any change in the state of the equipments and to manage the state of the equipments.

Thus, the control command is not transmitted if the equipments are already turned on when they receive a command instructing to turn on the equipments from the tag reader T.

In the foregoing embodiment, the user management device 112 stores the user presence/absence and the equipment use management tables for each tag reader T. However, the present invention is not limited thereto. For example, the user management device 112 may store only the number of users using the equipments. In that case, the equipments may be controlled in a manner that they are turned on if the number of users using the equipments is equal to or greater than one but turned off if the number of users is equal to zero.

(6) In the foregoing embodiment, there is illustrated control contents of turning on and off the equipments. However, the present invention is not limited thereto.

For example, the temperature of the air conditioning device may be controlled depending on the ID of the user existing in the coverage of the tag reader T. This can be realized in the following manner. The temperature at which a specific user feels pleasant is registered on an ID-by-ID basis. When the specific user alone is using the air conditioning device, the tag reader T transmits to the equipment control device C a command instructing to change the temperature of the air conditioning device to the registered temperature.

The luminance of the illumination device may be controlled depending on the number of users existing in the coverage of the tag reader. This can be realized in the following manner. The tag reader T counts the number of users registered in the equipment use management table. The tag reader T transmits a command to the equipment control device C to increase luminance of the illumination device when there are lots of users and reduce the luminance thereof when there are few users.

In the foregoing embodiment, the user presence/absence and the equipment use management tables of the user management device 112 are updated by causing the tag reader T to generate the user ID management list and to transmit the same to the user management device 112. However, the present invention is not limited thereto. For example, the user ID management list may be generated in the user management device 112. This can be realized in the following manner. The tag reader T transmits the ID information to the user management device 112. And then, prior to updating the user presence/absence and the equipment user ID management tables, the user management device 112 generates a user ID management list.

(8) In the foregoing embodiment, the ID information is read by the tag reader T and the user management is performed based on the ID information. However, the present invention is not limited thereto. In place of the tag reader T, it may be possible to use any other reading devices capable of reading the ID information. For example, an IC card reader or a living body information reader may be used. Alternatively, the ID information may be inputted by operating ten keys.

In case of using a reading device with no UHF wireless transmitting unit just like the tag reader, a separately-prepared UHF wireless transmitter needs to be connected to the reading device in order to transmit a command to the equipment control device C. The UHF wireless transmitter may be built in the reading device or may be attached to the outside of the reading device. One UHF wireless transmitter may be shared by a plurality of reading devices.

(9) In the foregoing embodiment, the ID information reading operation for unlocking and locking the door is performed by the hybrid reader H. However, the present invention is not limited thereto. In place of the hybrid reader H, it may be possible to use any other reading devices capable of reading the ID information. For example, a tag reader, an IC card reader or a living body information reader may be used. Alternatively, the ID information may be inputted by operating ten keys.

(10) In the foregoing embodiment, the determination unit 712 provided in the control unit 710 of the tag reader T determines which one of the equipments to be controlled, control contents to be performed and which one of the equipment control devices C to be supplied with the control commands. However, the present invention is not limited thereto. For example, a determination unit may be provided in the control unit 1121 of the user management device 112 so that the user management device 112 can determine which one of the equipments to be controlled, control contents to be performed and which one of the equipment control devices C to be supplied with the control commands. This can be realized by causing the tag reader T to receive the determination result of the user management device 112 and to transmit a command based on the determination result.

(11) In the foregoing embodiment, the hybrid reader H transmits the ID information to the entering/exiting management device 111. Upon receiving a successful authentication result from the entering/exiting management device 111, the hybrid reader H outputs a command instructing the door control unit to unlock the door. However, the present invention is not limited thereto. For example, the entering/exiting management device 111 may output a command instructing the door control unit to unlock the door. This can be realized by allowing the entering/exiting ID management device 111 to directly control the unlocking and locking of the door.

(12) In the foregoing embodiment, the authentication process is performed by the authentication unit 1102 of the control unit 1101 of the ID management server 110. However, the present invention is not limited thereto. For example, the control unit 1111 of the entering/exiting management device 111 and the control unit 1121 of the user management device 112 may include respectively an authentication unit so that the authentication process for the entrance/exit management can be performed by the entering/exiting management device 111 while the authentication process of the user management can be performed by the user management device 112. In this case, the ID information of users registered as authorized users in the equipment management system 100 and stored in the storage unit 1104 of the ID management server 110 are stored in the storage unit 1114 of the entering/exiting management device 111 as well as the storage unit 1124 of the user management device 112. The ID management server 110 is used to perform the operation of displaying the authentication results of the entering/exiting management device 111 and the user management device 112, and the operation of registering and deleting the ID information registered as the user of the equipment management system 100.

While the invention has been shown and described with respect to the embodiments, it will be understood by those skilled in the art that various changes and modifications may be made without departing from the scope of the invention as defined in the following claims.

What is claimed is:

1. An equipment management system coexisting with an equipment control system in which a load of an equipment is controlled by an equipment control server, comprising:
an equipment control device having a control unit connected to the equipment control server to transmit a control signal for controlling the load of the equipment in cooperation with the equipment control server;
an identifiable medium;
a reading device having an acquisition unit for acquiring identification information of the medium present in a management target area, a determination unit for determining presence/absence of a user carrying the medium in the management coverage depending on the acquisition situation of the identification information in the acquisition unit, and an instruction unit for instructing the control unit to control the load of the equipment depending on the determination result of the determination unit; and
an authentication server having an authentication unit for performing authentication based on the identification information acquired by the acquisition unit,
wherein the transmitting operation from the instruction unit of the reading device to the control unit of the equipment control device is performed in a wireless manner.

2. The equipment management system of claim 1, wherein the determination unit is designed to perform the determination based on the authentication result from the authentication unit.

3. The equipment management system of claim 2, wherein the instruction unit is adapted to perform the instruction by transmitting the determination result to the control unit, the control unit being adapted to control the load of the equipment by generating the control signal based on the determination result transmitted from the instruction unit and transmitting the control signal to the equipment.

4. The equipment management system of claim 2, wherein the instruction unit is adapted to perform the instruction by generating a command indicative of load control contents based on the determination result and transmitting the command to the control unit, the control unit being designed to control the load of the equipment by generating the control signal based on the command transmitted from the instruction unit and transmitting the control signal to the equipment.

5. The equipment management system of claim 1, wherein the medium is an integrated circuit (IC) card or a tag, and the reading device is a contactless IC card reader or an active tag reader.

6. The equipment management system of claim 2, wherein the medium is an integrated circuit (IC) card or a tag, and the reading device is a contactless IC card reader or an active tag reader.

7. The equipment management system of claim 3, wherein the medium is an integrated circuit (IC) card or a tag, and the reading device is a contactless IC card reader or an active tag reader.

8. The equipment management system of claim 4, wherein the medium is an integrated circuit (IC) card or a tag, and the reading device is a contactless IC card reader or an active tag reader.

9. The equipment management system of claim 1, wherein the equipment control device includes an operation switch for controlling the load of the equipment.

10. The equipment management system of claim 2, wherein the equipment control device includes an operation switch for controlling the load of the equipment.

11. The equipment management system of claim 3, wherein the equipment control device includes an operation switch for controlling the load of the equipment.

12. The equipment management system of claim 4, wherein the equipment control device includes an operation switch for controlling the load of the equipment.

13. The equipment management system of claim 9, wherein the operation switch is directly or remotely operated and is attached to a construction material.

14. The equipment management system of claim 10, wherein the operation switch is directly or remotely operated and is attached to a construction material.

15. The equipment management system of claim 11, wherein the operation switch is directly or remotely operated and is attached to a construction material.

16. The equipment management system of claim 12, wherein the operation switch is directly or remotely operated and is attached to a construction material.

17. The equipment management system of claim 1, wherein the equipment includes an illumination device and/or an conditioning device.

18. The equipment management system of claim 2, wherein the equipment includes an illumination device and/or an air conditioning device.

19. The equipment management system of claim 3, wherein the equipment includes an illumination device and/or an air conditioning device.

20. The equipment management system of claim 4, wherein the equipment includes an illumination device and/or an air conditioning device.
